(19) United States
(12) Patent Application Publication
(10) Pub. No.: US 2026/0175338 A1
(43) Pub. Date: Jun. 25, 2026

(54) WORKPIECE TRAY OF A WORKPIECE MAGAZINE AND METHOD FOR COMPUTER-ASSISTED TRAY LOADING

(71) Applicant: Condor Custom Solutions GmbH & Co. KG, Saizkotten (DE)

(72) Inventors: Sebastian RUSCHE, Geseke (DE); Dominik SCHULTE, Delbrück (DE)

(21) Appl. No.: 19/426,561

(22) Filed: Dec. 19, 2025

(30) Foreign Application Priority Data
Dec. 19, 2024 (DE) 10 2024 138 904.4

(51) Int. Cl. B23Q 3/155

(52) U.S. Cl. CPC B23Q 3/15503

(57) ABSTRACT

A workpiece tray of a workpiece magazine located upstream of a mechanical processing device optimally positions workpiece blanks on the workpiece tray. The workpiece blanks are manually positioned on a carrier plate with optimal distribution and safely, in a rapid, simple, and very precise manner and with high repeatability in connection with the greatest possible functional reliability, by employing a method for computer-assisted tray loading of the workpiece tray. The surface of the carrier plate has a multiplicity of equidistant openings with equal sizes, disposed in regular rows and columns, as well as a multiplicity of workpiece spacers equipped with detent bodies extending from their bottoms downwards into the openings. The workpiece spacers have support surfaces facing upwards for corner or edge partial contact surfaces of the workpiece blanks as well as spacer blocks or edge blocks extending vertically in between, having lateral positioning surfaces for the workpiece blanks.

### CROSS-REFERENCE TO RELATED APPLICATION

This application claims the priority, under 35 U.S.C. § 119, of German Patent Application DE 10 2024 138 904.4, filed Dec. 19, 2024; the prior application is herewith incorporated by reference in its entirety.

### FIELD AND BACKGROUND OF THE INVENTION

The invention refers to a workpiece tray of a workpiece magazine of a mechanical processing device having workpiece blanks manually provided on a carrier plate, and a method for computer-assisted tray loading.

A method and a device for partially automated loading of a machine tool is known from German Patent DE 10 2004 054 247 C5, in which, after provision of a workpiece on a transport device, it is transported into a workpiece receiving position, then grasped by a workpiece grasper and moved by it to the working region of a processing machine, resulting in processing of the workpiece at such location.

That method and device include the disadvantage of mechanical efforts for transporting a workpiece blank to the processing machine.

### SUMMARY OF THE INVENTION

It is accordingly an object of the invention to provide a workpiece tray of a workpiece magazine and a method for computer-assisted tray loading, which overcome the hereinafore-mentioned disadvantages of the heretofore-known devices and methods of this general type.

In particular, the object of the invention is to provide an optimized provision of workpiece blanks upstream of a processing machine, wherein provision on a workpiece tray of a workpiece magazine should be feasible in a rapid, simple, and very precise manner and with high repeatability in connection with best possible functional reliability, and a maximum number of workpiece blanks should be optimally distributed and safely disposed on the workpiece tray.

With the foregoing and other objects in view there is provided, in accordance with the invention, a workpiece tray of a workpiece magazine of a mechanical processing device having workpiece blanks manually provided on a carrier plate, wherein the surface of the carrier plate of the workpiece tray is provided with a multiplicity of equidistant openings having equal sizes, disposed in regular rows and columns, as well as having a multiplicity of workpiece spacers equipped with detent bodies extending from their bottoms downwards into the openings, and the workpiece spacers having support surfaces facing upwards for corner or edge partial contact surfaces of the workpiece blanks as well as spacer blocks or edge blocks extending vertically in between, having lateral positioning surfaces for the workpiece blanks.

With the objects of the invention in view, there is also provided a method for computer-assisted tray loading of a workpiece tray according to the invention, wherein the dimensions of the carrier plate and the openings disposed therein are stored in a programmable memory, as well as the type and shape of the workpiece spacers with their detent bodies, spacer blocks and edge blocks of the various support groups, as well as the possible dimensions of the workpiece blanks to be processed, and that only the dimensions of identical workpiece blanks currently to be processed is entered via an entry device, resulting in the computer program determining the optimal number of workpiece blanks per carrier plate, as well as the support group and the selection and the placement of the various workpiece spacers, wherein the result is displayed on a technical device for presentation of information and/or a display, after which the carrier plate is manually loaded by a person with the corresponding calculated workpiece spacers of a support group at the specified locations, and then loaded with the workpiece blanks.

The workpiece spacers, virtually together with the carrier plate of the workpiece tray, form a coupling mechanism so that several workpiece blanks to be processed are positionable with specified distances in numbers on a workpiece tray in a simple manner, wherein their distances towards each other are always correctly maintained so that a robotic arm may grasp such workpiece blanks one after the other and may forward them to a processing process, such as a milling process, in which the workpiece blanks are chucked in a vise of a milling machine and processed. Then, the processed workpiece blanks can be placed back onto the workpiece tray by using the robotic arm, or further conveyed out of the milling machine. As the workpiece blanks partially are supported on the workpiece spacers, it is beneficial that, in addition to locking of the detent bodies in the openings of the workpiece tray, they are fixed due to their deadweight.

Further beneficial configurations of the object of the invention result from and in combination with the following dependent claims.

According to a particularly preferred embodiment of the invention, the positioning surfaces are connected to mounting bevels in an upwards direction so that significant facilitation is achieved when manually loading, on the carrier plate of the workpiece tray, several workpiece blanks onto and between the workpiece spacers, particularly in case of heavier workpiece blanks, which thereby are inserted in their correct positions on the carrier plate of the workpiece tray immediately.

For example, for secure guiding of the outer corner of a workpiece blank, a workpiece spacer has two positioning surfaces facing each other, wherein the inner corner between the angled positioning surfaces beneficially corresponds to the angle of an outer corner of the workpiece blank so that this can be maintained at such location free from play.

Preferably, there is further provided a partial circular recess for receiving a corner edge of the outer corner of a workpiece blank between two angled positioning surfaces of a workpiece spacer so that this is not supported at its corner, but with a larger area at the lateral surfaces of the corner, so that only low surface pressures are applied to the workpiece spacers and the workpiece blanks instead of high concentrated or linear loads.

As the workpiece spacers have support surfaces for the workpiece blanks facing upwards, the deadweight of the workpiece blanks is beneficially used for holding the workpiece spacers with their detent bodies in the openings without providing further elaborate mechanical locking mechanisms for this, however, these may be provided, e.g. particularly in case of small corner supports that additionally may provide through-openings for passing bolts therethrough to be able to secure the workpiece spacer on the surface of the carrier plate by a bolt thread.

Beneficially, the workpiece spacers are configured as various variants, such as single corner support, double side support or triple, quad, or multi center support, so that the distances of the workpiece blanks next to each other or behind one another on a workpiece tray can be attached predeterminably in any manner.

Preferably, the spacer blocks or edge blocks of the workpiece spacers have a maximum height up to half the height dimension of the workpiece blanks so that they may not tilt even in case of high acceleration of a robotic arm that receives the workpiece tray and moves it to a location in a workpiece magazine.

According to a preferred configuration of the invention, all workpiece spacers of workpiece blanks having identical or similar dimensional ranges of their contact surfaces are colored as separate support groups using a color that differs from the color for support groups of workpiece spacers of workpiece blanks having deviating identical or similar dimensional ranges. This allows for very easy distinguishing and accurate detection and processing of the workpiece spacers that a person has to place on the workpiece tray.

Preferably, the detent bodies of the workpiece spacers have a circular cylindrical configuration, and the openings are configured as round blind holes or through holes having the same diameter as the detent bodies, wherein also variants of workpiece magazines with openings configured as crisscross slots and detent bodies configured as crosses or other variants with further coupling systems may be used.

Beneficially, the detent bodies are single-part; however, they also may be multi-part with or without detent lugs for openings provided with or not provided with undercuts so that the carrier plate of the workpiece tray according to the invention may be adapted to a multiplicity of requirements.

An embodiment of the carrier plate of the workpiece tray having workpiece spacers made of 3D-printed material, allowing for rapid and simple adaptation of new workpiece spacers to new shapes of workpiece blanks so that they can always be attached on a workpiece tray in a secure and accurately positioned manner, is particularly preferred.

Beneficially, the workpiece spacers have engagement recesses on their workpiece bottoms acting as assembly or disassembly aids as well as serving for saving of material.

For the new method for computer-assisted tray loading of a workpiece tray according to the invention, providing, via its software, a solution of the described technical problem by employing technical measures, the dimensions of the carrier plate and the openings disposed therein are stored in a programmable memory, as well as the type and shape of the workpiece spacers with their detent bodies, spacer blocks and edge blocks of the various support groups, as well as the possible dimensions of the workpiece blanks to be processed so that only the width and depth dimensions of identical workpiece blanks currently to be processed are to be entered via an entry device of the computer, resulting in the computer program determining the optimal number of workpiece blanks per carrier plate, as well as the support group and the selection and the placement of the various workpiece spacers of this support group, wherein the result is displayed on a technical device for presentation of information and/or a display of the device, after which the carrier plate is then manually loaded by a person with to the corresponding calculated workpiece spacers of a support group at the specified locations, and then loaded with the workpiece blanks.

For processing of high workpiece blanks having height dimensions greater than their width or depth dimensions, their height dimension is entered additionally via the entry device, whereupon the computer program beneficially selects and displays another support group having higher edge blocks and spacer blocks. This prevents tilting of the workpiece blanks on the workpiece tray in case of higher lateral acceleration of a robotic arm during subsequent translation of the workpiece tray.

The computer program preferably selects an arrangement of the workpiece spacers symmetrically disposed to a center axis of the carrier plate and a basic row of the carrier plate facing a robotic arm, as the robotic arm laterally couples to the carrier plate in the direction of the center axis and moves the readily loaded workpiece tray to a storage place in a workpiece magazine for access after handling previous workpiece trays. Thus, the selected arrangement minimizes the occurring cantilever and bending moments around and transverse to an axis of the robotic arm.

Other features which are considered as characteristic for the invention are set forth in the appended claims.

Although the invention is illustrated and described herein as embodied in a workpiece tray of a workpiece magazine and a method for computer-assisted tray loading, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of the carrier plate of a workpiece tray with attached workpiece blanks;

FIG. 2 is a perspective view of a workpiece magazine similar to FIG. 1 without workpiece blanks;

FIG. 3 is a perspective view of a single corner support;

FIG. 4 is a top-plan view of the single corner support of FIG. 3;

FIG. 5 is an angled, top, perspective view of a double side support;

FIG. 6 is a top-plan view of the double side support of FIG. 5;

FIG. 7 is an angled, front, perspective view of a second double side support;

FIG. 8 is a top-plan view of the second double side support of FIG. 7;

FIG. 9 is a lateral perspective view of a quad center support; and

FIG. 10 is a top-plan view of the quad center support of FIG. 9.

### DETAILED DESCRIPTION OF THE INVENTION

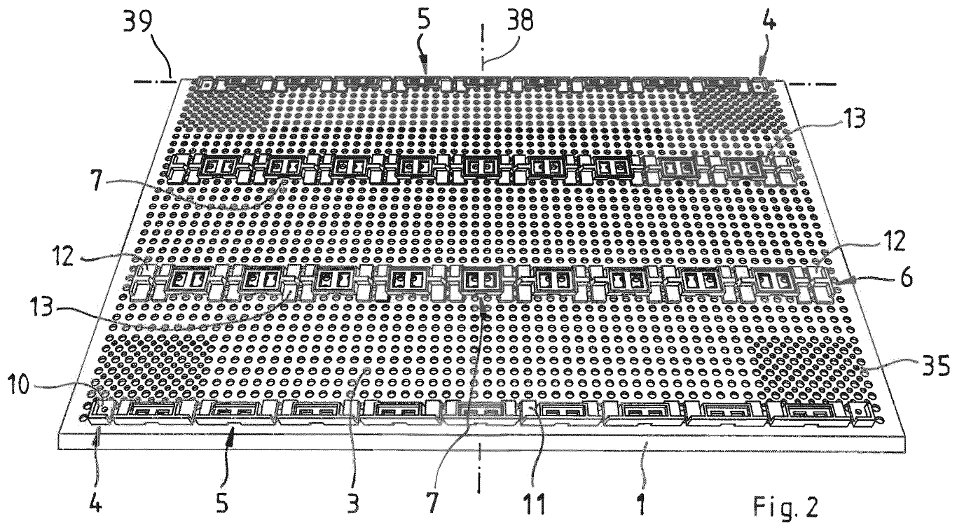

Referring now to the figures of the drawings in detail and first, particularly, to FIG. 2 thereof, there is seen a workpiece tray of a workpiece magazine that is mainly formed of a carrier plate 1 with openings 3 disposed equidistantly and equally sized in its surface in regular rows and columns, being configured as blind holes or through holes. Bolt threads 35 for fastening workpiece spacers 4-7 can be disposed in the four corner regions of the carrier plate 1 between the openings 3, which can be provided with through-openings 29 shown in FIG. 4.

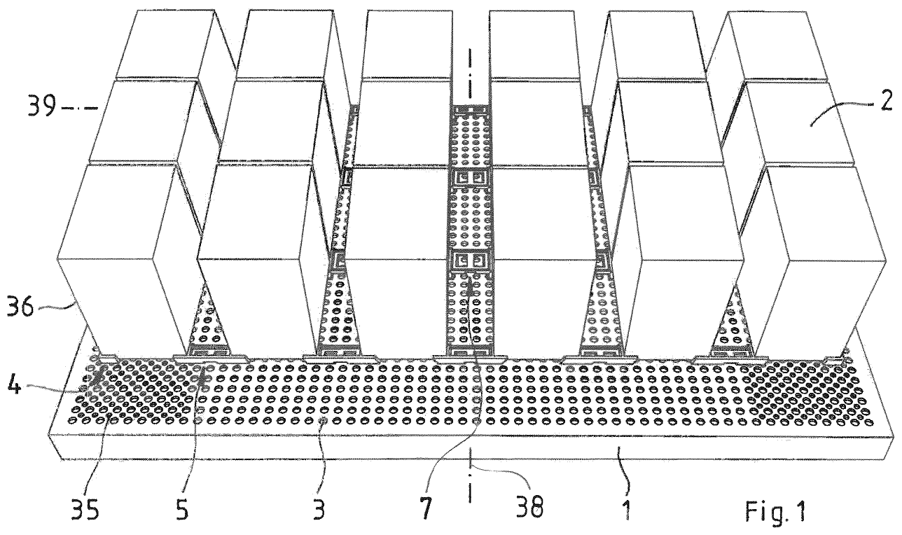

The workpiece spacers 4-7 are configured in various embodiments, such as single corner supports, double side supports or quad center supports, so that, as depicted in FIG. 1, workpiece blanks 2 attached in between are positioned in a safe manner and equally spaced apart from each other via their corner or edge regions of their partial contact surfaces. The drawings do not contain spacer blocks 31-34 or edge blocks 30 of the workpiece spacers 4-7 with different height dimensions that may extend up to half the height dimension of the workpiece blank 2, but also may be higher if desired or required.

The workpiece spacers 4-7 of workpiece blanks 2 having identical or similar dimensional ranges of their contact surfaces and, if applicable, other height dimensions are divided into separate support groups, each support group being colored in a distinct color, which is also not depicted in the drawings.

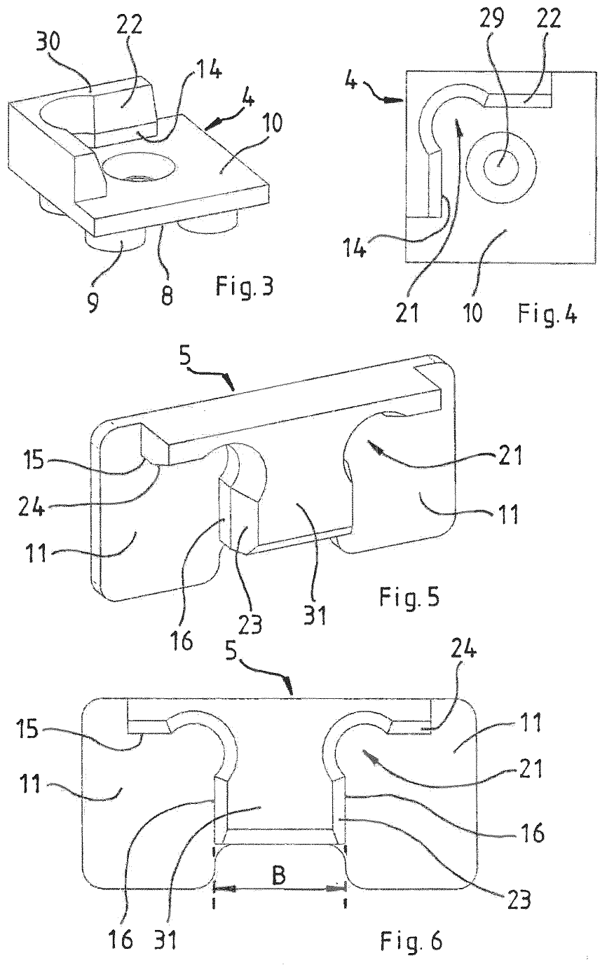

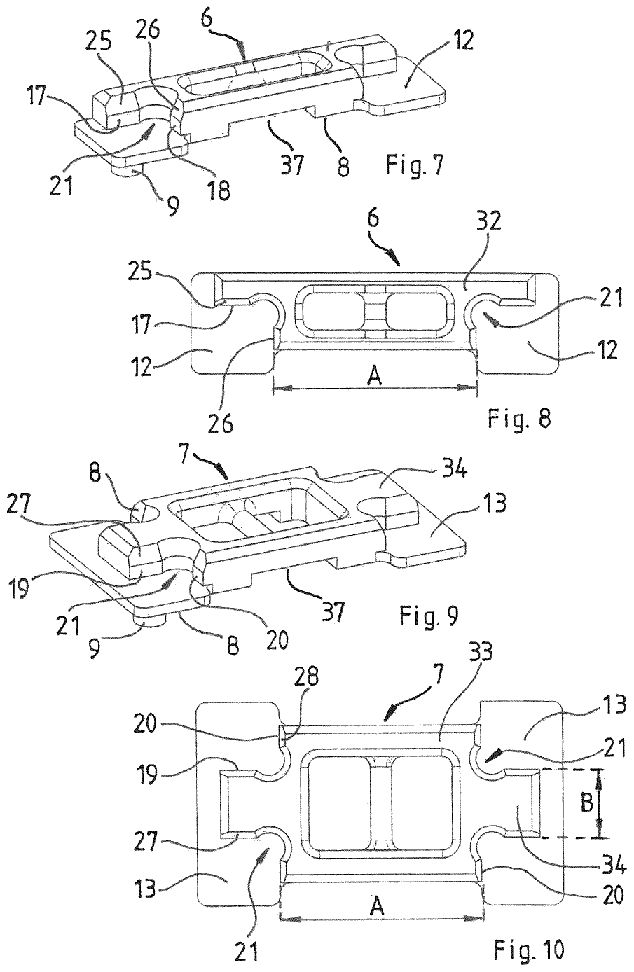

The workpiece spacers 4-7 have detent bodies 9 extending downward from their bottoms 8 into the openings 3, being configured circularly cylindrical here, as depicted in FIGS. 3, 7, and 9, wherein at least two such detent bodies 9 are provided for at a bottom 8 in each case. In addition, the bottoms 8 may be provided with engagement recesses 37, as shown in FIGS. 7 and 9, serving as disassembly aids and for saving of material.

Furthermore, the workpiece spacers 4-7 have support surfaces 10-13 facing upwards for corner or edge partial contact surfaces of the workpiece blanks 2 so that they fix the workpiece spacers 4-7 due to their deadweight. The possible configuration of the detent bodies 9 as multi-part shape, with or without detent lugs, for openings 3 provided with or not provided with undercuts, is provided in the scope of protection of the patent claims.

Spacer blocks 31-34 or edge blocks 30 with lateral positioning surfaces 14-20 for the workpiece blanks 2 are provided for between the lateral support surfaces 10-13 for the workpiece blanks 2, wherein the workpiece spacers 5, 6, being configured as double side support, are equipped with spacer blocks 31, 32 with lateral distances A, B from parallel positioning surfaces 14-20 corresponding to the same distance A, B of the positioning surfaces 14-20 of the workpiece spacer 7 configured as quad center support so that the workpiece blanks 2 can be disposed on the workpiece tray in rows and columns parallel to each other and having equal distances from each other.

The positioning surfaces 14-20 of the workpiece spacers 4-7 are connected to mounting bevels 22-28 facing upwards to facilitate insertion of the workpiece blanks 2 between the workpiece spacers 4-7.

The inner corner is equipped with a partial circular recess 21, between two positioning surfaces 4-20 of an outer corner 36 of a workpiece blank 2 that are angled towards each other, for receiving a corner edge of the outer corner 36 of a workpiece blank 2 so that this is not supported at its other corners 36, but directly laterally with regard to such corners, reducing the mechanical load both on a workpiece blank and on the workpiece spacers 4-7.

The workpiece spacers 4-7 are made of 3D-printed material, in particular plastics, and may be rapidly and affordably adapted to other geometries of workpiece blanks 2 and reprinted, wherein a center support, for example, could have fewer or greater than four support surfaces.

Here, the arrangement of workpiece blanks 2 is made symmetrically with regard to a center axis 38 and based on a basic row 39 of openings 3 in the carrier plate 1 close to a robotic arm.

The following is a summary list of reference numerals and the corresponding structure used in the above description of the invention:
1 carrier plate
2 workpiece blank
3 opening
4 workpiece spacer
5 workpiece spacer
6 workpiece spacer
7 workpiece spacer
8 bottom
9 detent body
10 support surface
11 support surface
12 support surface
13 support surface
14 positioning surface
15 positioning surface
16 positioning surface
17 positioning surface
18 positioning surface
19 positioning surface
20 positioning surface
21 partial circular recess
22 mounting bevel
23 mounting bevel
24 mounting bevel
25 mounting bevel
26 mounting bevel
27 mounting bevel
28 mounting bevel
29 through recess
30 edge block
31 spacer block
32 spacer block
33 spacer block
34 spacer block
35 bolt thread
36 outer corner
37 engagement recess
38 center axis
39 basic row

1. A workpiece tray of a workpiece magazine of a mechanical processing device, the workpiece tray comprising:
workpiece blanks having corner and edge partial contact surfaces;
a carrier plate for manually receiving said workpiece blanks, said carrier plate having a surface provided with a multiplicity of equidistant openings having equal sizes and being disposed in regular rows and columns; and
a multiplicity of workpiece spacers having bottoms and detent bodies extending from said bottoms downwards into said openings;
said workpiece spacers having support surfaces facing upwards for said corner or edge partial contact surfaces of said workpiece blanks; and
said workpiece spacers having spacer blocks or edge blocks extending vertically in between said support surfaces, and said spacer blocks or edge blocks having lateral positioning surfaces for said workpiece blanks.

2. The workpiece tray of a workpiece magazine according to claim 1, wherein said positioning surfaces are connected to mounting bevels in an upwards direction.

3. The workpiece tray of a workpiece magazine according to claim 1, wherein two of said lateral positioning surfaces corresponding to an outer corner of one of said workpiece blanks each are angled towards each other.

4. The workpiece tray of a workpiece magazine according to claim 3, wherein an inner corner between two of said angled positioning surfaces is equipped with a partial circular recess for receiving a corner edge of said outer corner of one of said workpiece blanks.

5. The workpiece tray of a workpiece magazine according to claim 1, wherein said workpiece spacers are configured differently as a single corner support, a double side support or a triple or a multi-center support.

6. The workpiece tray of a workpiece magazine according to claim 1, wherein said spacer blocks or edge blocks of said workpiece spacers have a height not being higher than half of a height dimension of said workpiece blanks.

7. The workpiece tray of a workpiece magazine according to claim 1, wherein all of said workpiece spacers for said workpiece blanks having identical or similar dimensional ranges of their contact surfaces are colored as separate support groups using a color that differs from a color for said workpiece spacers for said workpiece blanks having deviating identical or similar dimensional ranges.

8. The workpiece tray of a workpiece magazine according to claim 1, wherein said detent bodies are circularly cylindrical, and said openings are configured as round blind holes or through holes with diameters being the same as diameters of said detent bodies.

9. The workpiece tray of a workpiece magazine according to claim 8, wherein said detent bodies are configured as single-part or multi-part bodies, with or without detent lugs for said openings being provided with or not provided with undercuts.

10. The workpiece tray of a workpiece magazine according to claim 1, wherein said workpiece spacers have through-openings for bolts, and said carrier plate has bolt threads within said surface for fastening said workpiece spacers.

11. The workpiece tray of a workpiece magazine according to claim 1, wherein said workpiece spacers are made of 3D-printed material.

12. The workpiece tray of a workpiece magazine according to claim 1, wherein said bottoms of said workpiece spacers are level, and said workpiece spacers are equipped with engagement recesses on said level bottoms.

13. A method for computer-assisted tray loading of a workpiece tray, the method comprising:
providing the workpiece tray according to claim 1;
storing, in a programmable memory, dimensions of said carrier plate and said openings in said carrier plate as well as a type and shape of said various workpiece spacers with said detent bodies, said spacer blocks and edge blocks of various support groups, as well as possible dimensions of said workpiece blanks to be processed;
using an entry device to only enter said dimensions of identical workpiece blanks currently to be processed, resulting in a computer program determining an optimal number of said workpiece blanks per carrier plate, as well as said various support groups and a selection and placement of said various workpiece spacers;
displaying a result on a technical device for at least one of presentation of information or a display; and
subsequently manually loading said carrier plate by a person with corresponding calculated workpiece spacers of a support group at specified locations, and then loading said carrier plate with said workpiece blanks.

14. The method according to claim 13, which further comprises, for processing high workpiece blanks having height dimensions greater than their width or depth dimensions, additionally entering said height dimensions using said entry device, and using said computer program to select and display a support group having higher edge blocks and spacer blocks.

15. The method according to claim 14, which further comprises using said computer program to select an arrangement of said workpiece spacers symmetrically allocated to a center axis of said carrier plate and a basic row of said carrier plate facing a robotic arm.
